(19) United States
(12) Patent Application Publication
(10) Pub. No.: US 2005/0191959 A1
(43) Pub. Date: Sep. 1, 2005

(54) System and method for time shifting selective content from an audio broadcast

(76) Inventors: David T. Horoschak, Furlong, PA (US); Jeffrey D. Ollis, Dresher, PA (US)

Correspondence Address: Motorola, Inc., 101 Tournament Drive, Horsham, PA, 19044, US

(21) Appl. No.: 10/790,157

(22) Filed: Mar. 1, 2004

(51) Int. Cl. H04Q 7/00

(52) U.S. Cl. 455/3.01; 455/3.03; 455/3.06

(57) ABSTRACT

A system and method for time shifting traditional radio broadcast signals by selectively recording portions of a traditional radio broadcast signal for playback at subsequent pre-selected times or intervals is disclosed. The present system and method provides for a selection recognition engine which constantly monitors traditional broadcast radio signals via an audio tuner for pre-defined recording triggers, such as voice recognition, signalling tone, or pre-defined time. When a pre-defined recording triggers occurs, the selection recognition engine begins recording desired portions of the traditional radio broadcast, at a pre-selected frequency associated with the pre-defined recording trigger, to an audio capture memory. The duration of the recording may preferably be a fixed duration, e.g., one minute, or until a pre-defined recording stop trigger. The current digital audio stream is then interrupted for playback of the recorded portion of the traditional radio broadcast signal at the pre-selected times or intervals.

### FIELD OF THE INVENTION

The present invention relates to audio broadcast signals. More specifically, the present invention relates to the selectively recording of portions of an audio broadcast signal for subsequent playback at pre-selected times or intervals.

### BACKGROUND OF THE INVENTION

With the advent and popularity of digital media, many consumers spend countless hours each day listening to pre-recorded music stored on digital media. Towards this end, multiple pieces of digital music media, e.g., disc compacts, MINI DISC, etc., and digital media players, e.g., compact disc players, are often found in numerous automobiles as well as consumer audio devices in the home. Further, with the widespread use and acceptance of MP3 and MPEP4 audio, such compression formats allow an individual to have thousands of pre-recorded songs at their disposal, on media of their choosing. Today, there even exist digital music providers which stream commercial free channels of digital music, where the consumer simply must select a desired genre.

As a result of the above, whether in an automobile or at home, many consumers have vastly reduced the time they listen to traditional broadcast radio (“TBR”). (TBR as used herein excludes digital audio broadcast services described above, such as XM RADIO.) This reduction in TBR listening does have a negative repercussion in that consumers no longer receive current news updates often found in TBR broadcasts. Such news updates may include significant information, including, but not limited to, weather reports, storm alerts, traffic reports/accidents, terrorist warnings, stock quotes, or even sports scores. Typically such information is broadcast over FM stations intermittently, or AM stations repeatedly throughout the day. In fact, some AM stations provide specific types of reports at a pre-determined times. For example, 1010WINS (1010 AM) in New York, N.Y. provides TRAFFIC ON THE ONES, where at one minute after each 10 minute interval, e.g., 8:01 a.m., 8:11 a.m., 8:21 a.m., etc., a local traffic report is broadcast.

Thus, what is needed is a system and method to allow consumers to continue to utilize their vast array of digital audio files (music) and/or digital music broadcast station subscription (“DBR”), e.g., XM RADIO, while still receiving pertinent information broadcast over TBR.

### SUMMARY OF INVENTION

An object of the present invention is to provide for time shifting TBR signals by selectively recording portions of a TBR signal for playback at subsequent pre-selected times or intervals.

In order to achieve this objective, as well as others which will become apparent in the disclosure below, the present invention provides for a system including an audio tuner, digital audio player, selection recognition engine (“SRE”), audio capture memory, audio selector, and audio amplifier.

In an exemplary embodiment of the present invention, the SRE constantly monitors TBR signals via the audio tuner for pre-defined recording triggers (“Record Trigger”), such as voice recognition, signalling tone, or pre-defined time. When a Record Trigger occurs, the SRE begins recording a desired portion of the TBR, at a pre-selected frequency associated with the Record Trigger, to the audio capture memory. The duration of the recording may preferably be a fixed duration, e.g., one minute, or until a pre-defined recording stop trigger (“Stop Trigger”) occurs.

In accordance with an exemplary embodiment of the present invention, once the desired portion of the TBR signal is recorded (hereinafter referred to as a recorded pre-defined audio broadcast signal (“PABS”)), the SRE sends an audible and/or visual indication to the user indicating that a PABS has been recorded and is ready to be dispatched to the user for listening. Here, the user may select, via the audio selector, to have the user's current digital audio stream (CD, MP3, DBR, etc.) interrupted immediately to listen to the PABS, or select to have the PABS dispatched at the next available break in the current digital audio stream, e.g., after the current song on a CD is finished. Further, the audio selector may have a pre-programmed default, e.g., play PABS after the current song is finished, as well as different indicators or defaults for different types of PABS captures, e.g., weather report, stock report, etc.

Thus, the present system and method provides for time shifting TBR signals by selectively recording portions of a TBR signal for playback at subsequent pre-selected times or intervals.

### BRIEF DESCRIPTION OF THE DRAWINGS

For a complete understanding of the present invention and the advantages thereof, reference is now made to the following description taken in conjunction with the accompanying drawings in which like reference numbers indicate like features, components and method steps, and wherein:

FIG. 1 is an illustration of a system for time shifting TBR signals by selectively recording portions of a TBR signal for playback at subsequent pre-selected times or intervals in accordance with an exemplary embodiment of the present invention; and

FIG. 2 is a flow diagram showing the basic process flow for time shifting TBR signals by selectively recording portions of a TBR signal for playback at subsequent pre-selected times or intervals in accordance with an exemplary embodiment of the present invention.

### DESCRIPTION OF A PRESENTLY PREFERRED EMBODIMENT

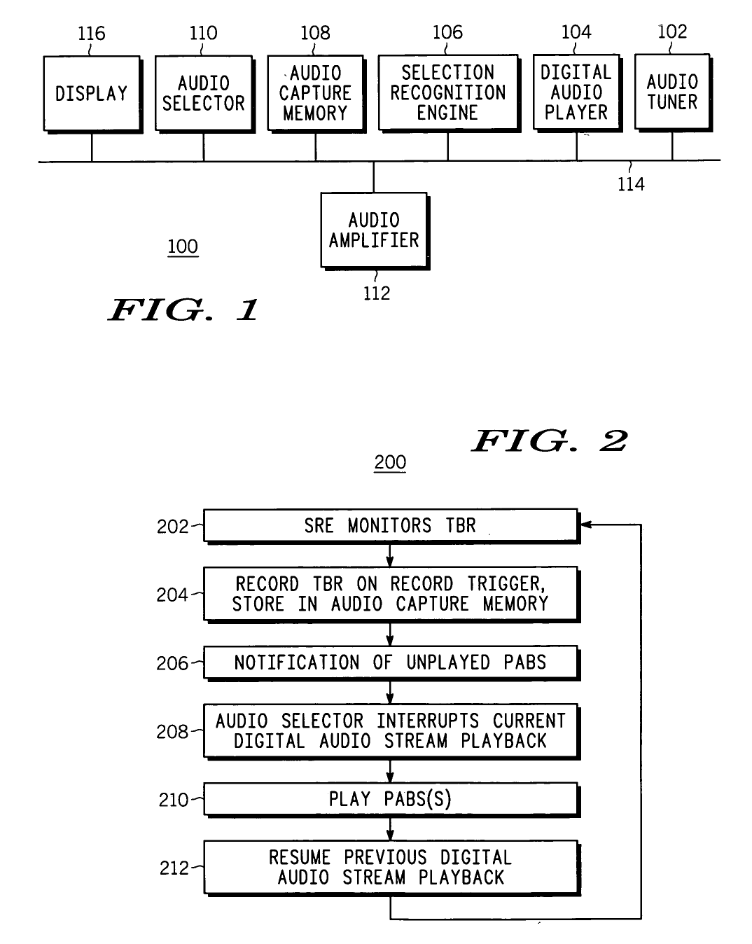

Referring to FIG. 1, system 100 is shown. System 100 is a system for time shifting TBR signals by selectively recording portions of a TBR signal for playback at subsequent pre-selected times or intervals in accordance with an exemplary embodiment of the present invention. System 100 includes an audio tuner 102, digital audio player 104, SRE 106, audio capture memory 108, audio selector 110, and display 116. In one preferred embodiment, system 100 may also include an audio amplifier 112. Alternatively, in another embodiment, system 100 may not include an audio amplifier, in which case an outboard amplifier would be used to amplifier the audio signal for audible delivery to the user. Audio tuner 102, digital audio player 104, SRE 106, audio capture memory 108, audio selector 110, display 116 and audio amplifier 112 preferably communicate and transmit audio signals over bus 114. Bus 114 may be a digital bus or hybrid digital and analog bus. Alternatively, system 100 may have separate and/or multiple digital and analog buses.

In accordance with an exemplary embodiment of the present invention, audio tuner 102 is a frequency tuner used to receive modulated radio frequency (“RF”) signals. Digital audio player 104 is preferably is a digital audio playback device capable of playing back standard Redbook audio (CD audio), MP3 audio, MPEP4 (ACC) audio, AC-3 audio, or to receive and playback DBR signals. SRE 106 is the core of the present invention and may preferably contain a processor, and memory, where the memory is preferably random access memory. SRE 106 manages the recording of pre-defined TBR signals for subsequent playback, as described in detail below. SRE 106 preferably includes speech (voice) recognition abilities, as well as signal frequency detection, e.g., the ability to distinguish between a 1.2 KHz tone and a 800 Hz tone, for example. Speech recognition and signal frequency detection system and methods are well known in the art. The audio capture memory 108 may be random access memory, flash memory, a hard drive, optical drive, or optical-magnetic drive. Audio capture memory 108 stores TBR signals recorded by SRE 106 (resulting in PABS(s)). Audio selector 110 may preferably contain a processor, and memory, where the memory is preferably random access memory. Audio selector 110 manages the interruption of the current digital audio playback stream, for playback of a PABS, and then resumes the previously interrupted digital audio playback stream. Display 116 is a conventional data display used by the audio selector 110, SRE 106, digital audio player 104, or audio tuner 102 to display various status messages to the user, including the existence of a PABS. Display 116 may also include a user interface for programming which TBR portions to record (described below) or method of interruption by the audio selector 110. Further, where an audio amplifier 112 is included in system 100, audio amplifier 112 amplifiers the audio signal to a current (i) level appropriate to power loudspeakers or a headphone(s). Audio amplifier 112 may receive a digital or analog signal as input, and may output an amplified digital or analog signal, depending on the loudspeakers or headphone signal reception format.

Referring to FIG. 2, in operation, in accordance with an exemplary embodiment of the present invention, the SRE 106 constantly monitors TBR signals via the audio tuner 102 for a Record Trigger, such as voice recognition, signalling tone, or pre-defined time, in step 202. Recording Triggers may be pre-defined by the user in the SRE 102, and/or be pre-programmed into the SRE 106 based upon conventional or standardized TBR tones or events. For example, a 1.2 KHz tone may be conventionally known to be the prefix to a weather report. Further, audio tuner 102 preferably may receive multiple RF frequencies, so as to allow the SRE 106 to monitor multiple TBR signals (stations) simultaneously.

When a Record Trigger occurs, the SRE 106 begins recording a desired duration of the TBR, at the pre-selected frequency associated with the Record Trigger, to the audio capture memory 108, in step 204. The recording may preferably be in the form of MP3 audio, MPEP4 audio, or AC-3 audio format. The duration of the recording may preferably be a fixed duration, e.g., one minute, or until a Stop Trigger occurs. A Stop Trigger may be a change in orators voice, where speech recognition is the Record Trigger; or a conventional or standardized TBR tone or event, for example, a 800 Hz tone may be conventionally known to be the suffix to a weather report. Please note, the present invention is described with reference to a single PABS solely for easy of explanation. It should be understood that system 100 may handle multiple PABS signals.

In accordance with an exemplary embodiment of the present invention, once the desired portion of the TBR signal is recorded (PABS), the SRE 106 may send an audible and/or visual indication to the display 116 indicating that a PABS has been recorded and is ready to be dispatched for listening, in step 206. Here, the user may select, via the audio selector 110, to have the user's current digital audio stream (CD, MP3, DBR, etc.) interrupted immediately to listen to the PABS, or select to have the PABS dispatched at the next available break in the current digital audio stream, e.g., after the current song on a CD is finished. Further, the audio selector 110 may have a pre-programmed default, e.g., play PABS after the current song is finished, as well as different indicators or defaults for different types PABS captures, e.g., whether report, interrupt immediately; stock report, wait until current song in audio stream is complete, then interrupt; etc. Thus, in accordance with the default or user selected PABS interrupt condition, the audio selector 110 interrupts the current digital audio stream, in step 208, and then the audio selector 110 begins to play the pending PABS from audio capture memory 108, in step 210. In accordance with an exemplary embodiment of the present invention, PABS is played through the digital audio player 104. After the PABS has completed playback, the audio selector 110, resumes playback of the previously interrupted digital audio stream, in step 212.

Thus, the present system and method provides for time shifting TBR signals by selectively recording portions of a TBR signal for playback at subsequent pre-selected times or intervals.

Although the invention has been described herein by reference to an exemplary embodiment thereof, it will be understood that such embodiment is susceptible of modification and variation without departing from the inventive concepts disclosed. For example, the above-described system and method may be applicable to time shifting digital broadcast radio. Further, the above system and method may be used in a stationary location, e.g., a home, or moving vehicles, e.g., automobile. All such modifications and variations, therefore, are intended to be encompassed within the spirit and scope of the appended claims.

1. A system for time shifting radio broadcast signals, said system comprising:
an audio tuner, said audio tuner tuning frequencies for reception of said radio broadcast signals; and
a selection recognition engine coupled to said audio tuner, said selection recognition engine monitoring said radio broadcast signals for pre-defined recording triggers and selectively recording portions of a radio broadcast signal, in response to said recording triggers, for playback at a playback device at subsequent pre-selected times or intervals.

2. The system of claim 1, further comprising an audio capture memory coupled to said selection recognition engine, said audio capture memory storing recorded portions of said radio broadcast signal.

3. The system of claim 2, wherein said audio capture memory comprises at least one of random access memory, flash memory, a hard drive, optical drive, and optical-magnetic drive.

4. The system of claim 1 further comprising a digital audio player, said digital audio player providing playback of a digital audio stream.

5. The system of claim 1 further comprising an audio selector, said audio selector managing an interruption of said current digital audio stream, for playback of a said recorded portion of said radio broadcast signal, and resumption of said digital audio stream previously interrupted.

6. The system of claim 4, wherein said audio selector comprises a user interface.

7. The system of claim 1, wherein said digital audio player comprises at least one of a Redbook audio player, MP3 audio player, MPEP4 audio player, and AC-3 audio player.

8. The system of claim 1, wherein said selection recognition engine comprises a speech recognition unit.

9. The system of claim 1, wherein said selection recognition engine comprises a frequency detection unit.

10. The system of claim 1, wherein said record trigger comprises at least one of voice recognition, signalling tone, and pre-defined time.

11. A method for time shifting radio broadcast signals, said method comprising the steps of:
monitoring radio broadcast signals for a pre-defined recording trigger;
recording at least a portion of a radio broadcast signal upon an occurrence of said recording trigger at a pre-selected frequency associated with said record trigger; and
storing a recorded portion of said radio broadcast signal.

12. The method of claim 11 further comprising the steps of:
stopping a current digital audio stream playback in response to the presence of said recorded portion of said radio broadcast signal;
playing said recorded portion of said radio broadcast signal; and
resuming said digital audio stream previously interrupted.

13. The method of claim 11, wherein said record trigger comprises at least one of voice recognition, signalling tone, and pre-defined time.

14. The method of claim 11, where said recording comprising digitally compressing said recorded portion of said radio broadcast signal in at least one of MP3 audio, MPEP4 audio, and AC-3 audio format.

15. The method of claim 12 further comprising the step of stopping said recording of said radio broadcast signal upon the occurrence of a stop trigger.

16. The method of claim 15, wherein said stop trigger comprises at least one of a fixed time after said start of said step of recording, a pre-defined recording stop time, voice recognition, change in an orators voice, a standardized tone, and standardized event.

17. The method of claim 12 further comprising the step of notifying when a recorded portion of a radio broadcast signal has been recorded but not yet played back.

18. The method of claim 17, wherein said step of notifying when a recorded portion of a radio broadcast signal has been recorded but not yet played back comprises providing an audible indication.

19. The method of claim 17, wherein said step of notifying when a recorded portion of a radio broadcast signal has been recorded but not yet played back comprises providing a visual indication.

20. The method of claim 12, wherein said step of stopping said digital audio stream in response to presence of said recorded portion of said radio broadcast signal occurs in response to a selection input, said selection input determining when to stop said digital audio stream for playback of said recorded portion of said radio broadcast signal.

21. The method of claim 12, wherein said step of stopping said digital audio stream in response to presence of said recorded portion of said radio broadcast signal is in response to a preset default condition.
